(19) United States
(12) Patent Application Publication
(10) Pub. No.: US 2015/0375781 A1
(43) Pub. Date: Dec. 31, 2015

(54) METHODS AND SYSTEMS FOR PROVIDING STEERING COMPENSATION

(71) Applicant: GM Global Technology Operations LLC, Detroit, MI (US)

(72) Inventors: KENNETH L. OBLIZAJEK, TROY, MI (US); JOHN D. SOPOCI, COMMERCE TOWNSHIP, MI (US)

(21) Appl. No.: 14/316,594

(22) Filed: Jun. 26, 2014

(51) Int. Cl. B62D 6/08; B62D 5/04

(52) U.S. Cl. CPC B62D 6/08; B62D 5/04

(57) ABSTRACT

Methods and systems are provided for controlling an electric power steering system. In one embodiment, a method includes: storing a compensation table having compensation values that are associated with motor torque drive values; receiving a current motor torque drive signal; determining a compensation action the current motor torque drive signal; determining a compensation value based on the compensation action and the table; and generating a motor torque drive signal based on the compensation value.

### TECHNICAL FIELD

The present disclosure generally relates to steering systems of a vehicle, and more particularly relates to methods and systems for compensating a steering assist command to the steering system.

### BACKGROUND

A steering system of a vehicle allows a driver to steer front wheels of the vehicle. The steering system may be an electric power steering system that uses an electric motor to provide a steering assist to a driver of the vehicle, thereby reducing effort by the driver in steering the vehicle.

In some cases, unwanted vibrations in the steering system may occur due to internal periodic excitation such as tire/wheel imbalance, tire irregularities, brake rotor imbalance and lack of precision piloting of the rotating members. These vibrations may cause discrepancies in the signals relied upon by the steering system. It is desirable to compensate for these discrepancies.

Accordingly, it is desirable to provide methods and systems for developing compensation values for steering assist. It is also desirable to provide methods and systems for controlling the steering system based on the compensation values. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for controlling an electric power steering system. In one embodiment, a method includes: storing a compensation table having compensation values that are associated with motor torque drive values; receiving a current motor torque drive signal; determining a compensation action the current motor torque drive signal; determining a compensation value based on the compensation action and the table; and generating a motor torque drive signal based on the compensation value.

In one embodiment, a system includes an electric power steering system, a torque sensor associated with the electric power steering system, and a first module. The first module stores a compensation table having compensation values that are associated with motor torque drive values, receives a current motor torque drive signal, determines a compensation action the current motor torque drive signal, determines a compensation value based on the compensation action and the table, and generates a motor torque drive signal based on the compensation value.

### DESCRIPTION OF THE DRAWINGS

The present disclosure will hereinafter be described in conjunction with the following drawing figures, wherein like numerals denote like elements, and:

FIG. 1 is a functional block diagram of a vehicle that includes, among other features, a steering system in accordance with exemplary embodiments;

FIG. 2 is a functional block diagram of a vehicle that includes, among other features, a steering system and a compensation value determination system, in accordance with exemplary embodiments;

FIGS. 3-5 are graphs illustrating methods used in determining the compensation actions and values in accordance with exemplary embodiments;

FIG. 6 is a flowchart of a method for determining compensation values and actions in accordance with exemplary embodiments; and

FIG. 7 is a flowchart of a method of controlling the steering system according to the compensation values and actions in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

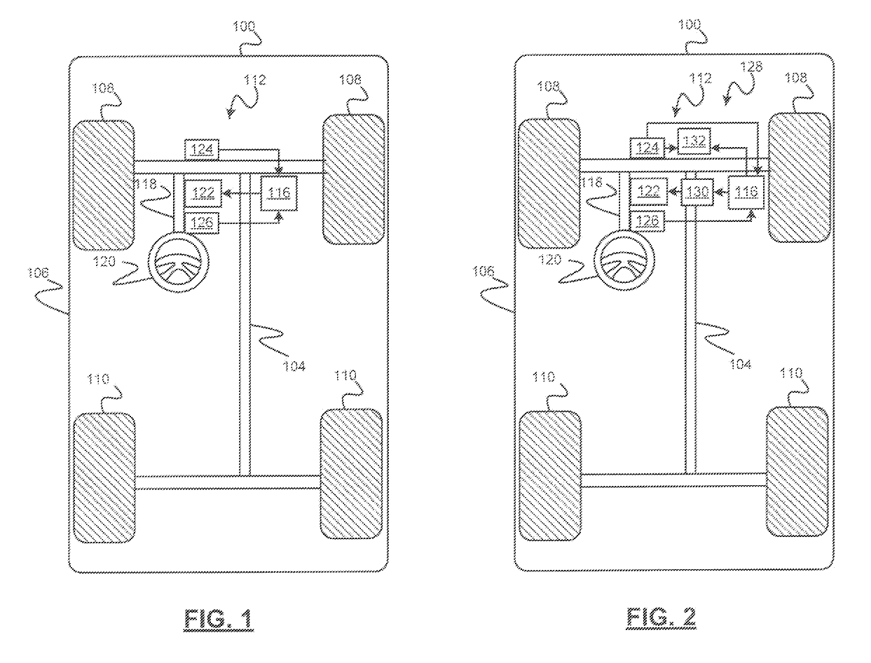

With reference to FIG. 1, a vehicle 100 is shown that includes a steering system 112 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

As depicted in FIG. 1, the vehicle 100 generally includes a chassis 104, a body 106, front wheels 108, rear wheels 110, a steering system 112, and a control module 116. The body 106 is arranged on the chassis 104 and substantially encloses the other components of the vehicle 100. The body 106 and the chassis 104 may jointly form a frame. The wheels 108-110 are each rotationally coupled to the chassis 104 near a respective corner of the body 106.

As can be appreciated, the vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). The vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and ethanol), a gaseous compound (e.g., hydrogen or natural gas) fueled engine, a combustion/electric motor hybrid engine, and an electric motor.

The steering system 112 includes a steering column 118 and a steering wheel 120. In various embodiments, the steering system 112 further includes various other features (not depicted in FIG. 1), such as a steering gear, hydraulic power steering (HPS), intermediate connecting shafts between the column and the gear, connection joints, either flexible or rigid, allowing desired articulation angles between the intermediate connecting shafts, and tie-rods. The steering gear, in turn, comprises a rack, input shaft, and internal gearing.

In various embodiments, the steering system 112 is an Electric Power Steering system (EPS) that includes a motor 122 that is coupled to the steering system 112, and that provides torque or force to a rotatable or translational member of the steering system 112 (referred to as assist torque). The motor 122 can be coupled to the rotatable shaft of the steering column 118 or to the rack of the steering gear. In the case of a rotary motor, the motor 122 is typically connected through a geared or belt-driven configuration enabling a favorable ratio of motor shaft rotation to either column shaft rotation or rack linear movement. The steering system 112 in turn influences the steerable front road wheels 108 during steering based upon the assist torque received from the motor 122 along with any torque received from a driver of the vehicle 100 via the steering wheel 120.

The steering system 112 further includes one or more sensors that sense observable conditions of the steering system 112. In various embodiments, the steering system 112 includes a torque sensor 124 and a position sensor 126. The torque sensor 124 senses a rotational torque applied to the steering system by for example, a driver of the vehicle 100 via the steering wheel 120 and generates torque signals based thereon. The position sensor 126 senses a rotational position of the steering wheel 120 and generates position signals based thereon. The time derivatives of these signals, furthermore, provide additional information about the changing states of the vehicle. For instance, the derivative of the rotational position of the steering wheel 120, provides the rotational velocity. Various operational states of the vehicle are inferred by these signals and their derivatives to enable desired control compensation actions.

The control module 116 receives the sensor signals and controls operation of the steering system 112 based thereon. In general, the control module 116 generates control signals to the motor to control the amount of motor torque provided to the steering system 112. The control module 116 generates the control signals based on compensation actions that are determined according to compensation systems and methods of the present disclosure. Compensation actions can include, for example, but are not limited to, cessation of certain control actions (e.g., momentarily for fractions of a second, for multiple seconds, or sustained for many seconds depending on the state); modifying the parameters of the control functions; or combinations of the cessation and the modifying. The modifying of the control parameters, in turn, can include alteration of the gain and phase compensation parameters depending on the state of the controls. In general, the control module 116 applies the compensation values to a motor torque command value based on a frequency and the operational state of the vehicle 100 and steering system 112. The operational state of the vehicle 100 and the steering system 112 can be determined from signals received from the vehicle 100 and/or the steering system 112.

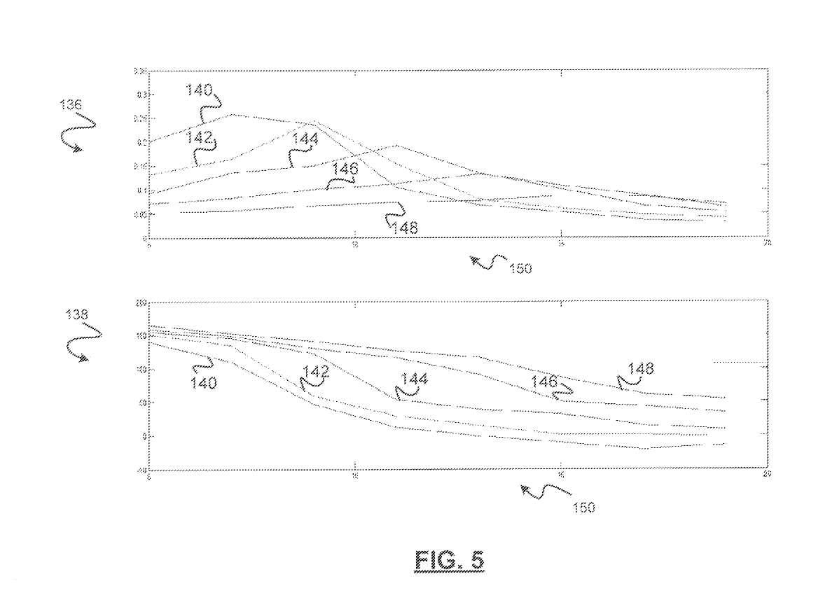

For example, as shown in FIGS. 3 and 4, the nonlinear control function of providing assist to the driver (FIG. 3) may influence the performance of other modules due to changing system dynamics (FIG. 4). For example, FIG. 3 illustrates the amount of current (shown on the vertical axis) that is supplied to the motor depending on the measured torque (shown on the horizontal axis) in the torque sensor. The instantaneous rates of change of assist 134 and 135, for 2 levels of torque will differ due to the nonlinear dependencies. The operation at these points may influence the overall dynamics of the system as displayed in FIG. 4, corresponding to the gain (top graph of FIG. 4) and the phase (lower graph of FIG. 4) of the system transfer function. These changing system dynamics may warrant control actions in other control functions, such as cessation, reduction, delay, or the like, of incremental drive command from the other module. These actions can be determined by the expected change in system dynamics depending on the level of sensed torque as shown along the horizontal axis of FIG. 3. In this manner, modifications of control parameters may be advantageously employed anticipating expected changes in the dynamic system performance. The lower graph of FIG. 3 is an example of the change in torque that might occur as torque is varied sinusoidally over time (vertical axis in the lower graph). As can be appreciated, this is only one example of the implementation of control actions based on expected changes in system dynamics as other implementations may be employed.

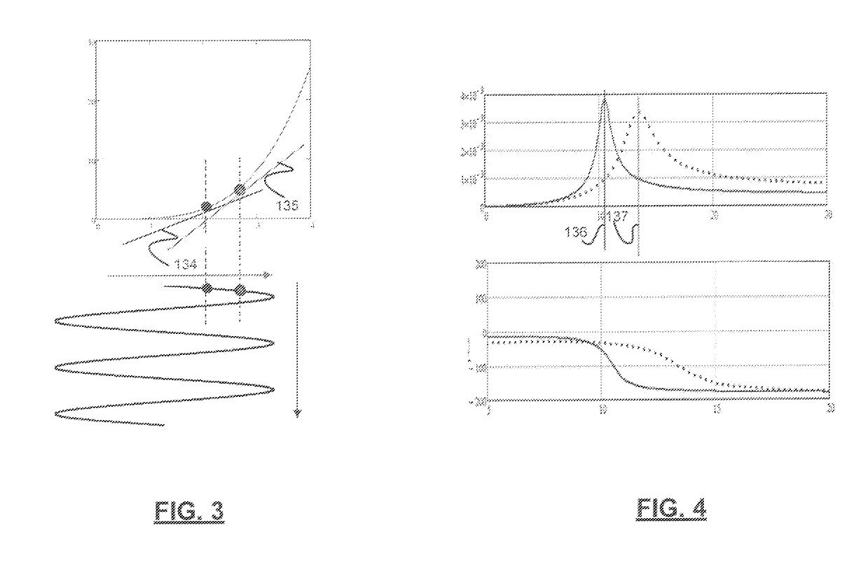

In various embodiments, the gain and phase compensation values are predetermined using compensation value determination methods and systems of the present disclosure. For example, as shown in FIG. 2, the vehicle 100 is further shown to include a compensation value determination system 128 that is associated with the steering system 112 in accordance with various embodiments. The compensation value determination system 128 includes a signal modification module 130, and a signal processing module 132. As can be appreciated, the signal modification module 130 and/or the signal processing module 132 may be implemented as a part of the control module 116 or separate (as shown). As can further be appreciated, all or parts of the signal processing module 132 may be implemented by a computer (not shown) that is remote from the vehicle 100 (e.g., if the processing is performed offline).

The signal modification module 130 receives an uncompensated control signal that requests a torque of the motor 122 from the control module 116 and generates a modified control signal based thereon. For example, the signal modification module 130 includes a dither generator that generates a dither signal and a combiner that combines (e.g., sums) the uncompensated control signal with the dither signal to generate a dithered control signal. The dithered control signal may be a superimposed sinewave signal that is generated at various frequencies. For example, the signal modification module 130 may vary the frequency based on dwell point testing, swept frequency testing, or other methods of varying the frequency. Dwell point testing, for example, holds the frequency constant for a brief period of time, increments the frequency, then holds again, and repeats until all desired frequencies are completed. Swept frequency testing, for example, continuously varies the frequency from a desired start to a desired end frequency at a slow rate of change of frequency. The rate of change of the frequency, furthermore, may be constant or, alternatively, may vary in order to achieve advantages in processing and interpretation. For example, the rate of change of frequency, may be proportional to the frequency in order to achieve even percentage changes in frequency over equal time periods.

The signal processing module 132 receives the uncompensated control signals from the control module 116 and torque signals that are generated by the torque sensor 124 during various steering maneuvers and processes the signals to determine the gain and phase compensation values. In general, the steering maneuvers produce data that represents continuous transient steering events that demand various amounts of motor torque. For example, the steering wheel 120 may be turned from left to right and right to left as the vehicle 100 is being driven at the speed X over a period of time Y.

Upon completion of the steering maneuvers, the signal processing module 132 processes the torque signals either offline or in realtime to determine the gain and phase compensation values. As shown in FIG. 5, the transfer functions are determined for the various levels of base assist (e.g., 0-8 A at 140, 5-10 A at 142, 8-12 A at 144, 10-15 A at 146, 15-20 A at 148, etc.) that were generated due to the steering events. The signal processing module 132 determines the transfer functions over the frequency ranges (as shown by the x-axis at 150 of both the bottom graph and the top graph) that are established by the dithered signal. The data of the transfer functions are analyzed over the frequency ranges to identify the relationship between the response and the base assist. The gain and the phase are determined based on the relationship.

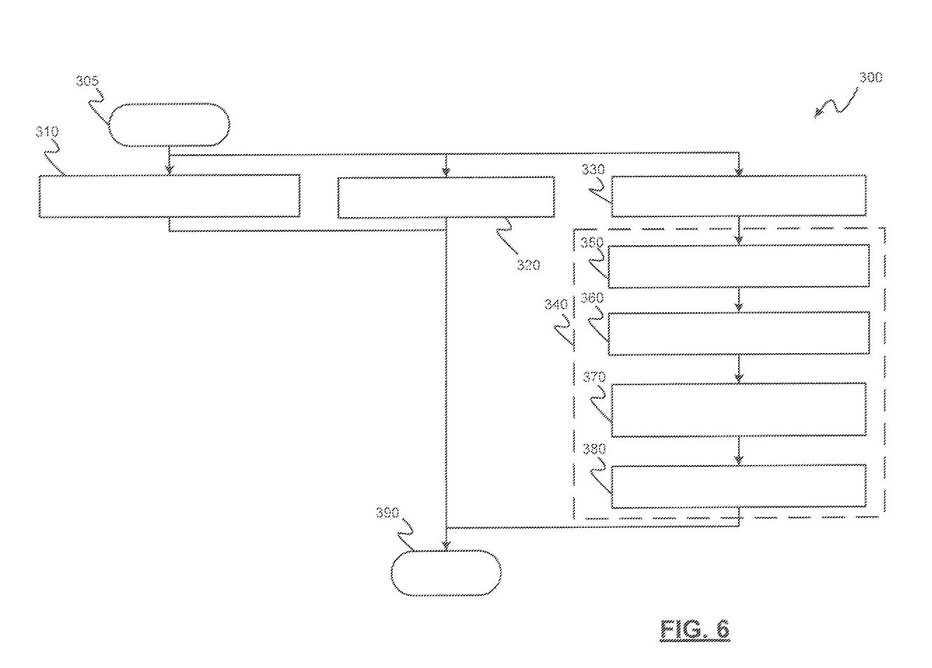

With reference now to FIG. 6, a flowchart of a method 300 for determining the gain and phase compensation values is shown in accordance with exemplary embodiments. The method 300 can be utilized in connection with the vehicle 100 and the compensation value determination system 128, in accordance with exemplary embodiments. As can be appreciated in light of the disclosure, the order of operation within the method is not limited to the sequential execution as illustrated in FIG. 6, but may be performed in one or more varying orders as applicable and in accordance with the present disclosure.

As depicted in FIG. 6, the method may begin at 305. At 310, the vehicle 100 is driven at speed X and certain steering maneuvers are performed as discussed above for a time Y. During the time Y, the modified control signals are generated to control the torque drive of the motor 122 at 320, and the torque sensor signals and the torque drive signals are received and logged at 330.

Upon completion of the driving maneuvers for the time Y, the logged data is processed at 340 (e.g., either offline or in realtime). For example, based on the data, transfer functions are determined for various levels of torque drive (e.g., 0-8 A, 5-10 A, 8-12 A, 10-15 A, 15-20 A, etc.) as discussed above at 350. The data of the transfer functions are segmented based on the frequency ranges at 360. The segmented data is then evaluated at each frequency range to determine the relationship between the torque drive and the frequency as discussed above at 370. The compensation values are determined based on the relationships and a compensation table is populated at 380. Thereafter, the method may end at 390.

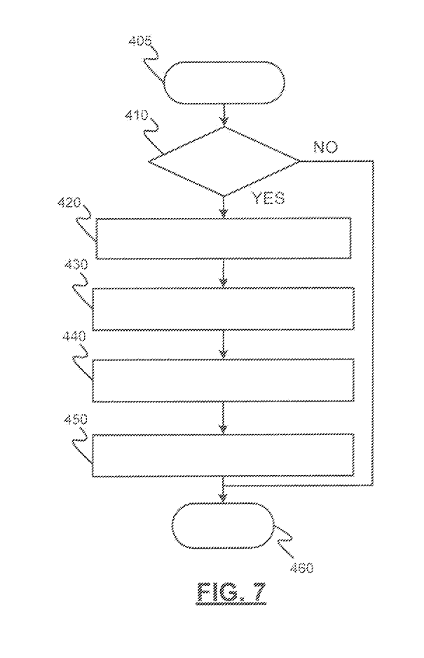

With reference now to FIG. 7, a flowchart of a method 400 for controlling the steering system using the compensation actions and values is shown in accordance with exemplary embodiments. The method 400 can be utilized in connection with the vehicle 100 and the control module 116, in accordance with exemplary embodiments. As can be appreciated in light of the disclosure, the order of operation within the method is not limited to the sequential execution as illustrated in FIG. 7, but may be performed in one or more varying orders as applicable and in accordance with the present disclosure.

As depicted in FIG. 7, the method may begin at 405. At 410, enable conditions are evaluated. For example, compensation may be enabled for certain conditions (e.g., smooth road shake conditions, road conditions such as rumble strips, etc.). If the enable conditions are met (e.g., one or more of the conditions are occurring), the torque drive values are received at 420. The compensation actions and values are determined based on the torque drive values at 430. The modified control signal is determined based on the compensation values at 440. The control signal is generated to control the motor at 430 based on the modified control signal at 450. Thereafter, the method may end at 460.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A control method of controlling an electric power steering system, the control method comprising:
storing a compensation table having compensation values that are associated with motor torque drive values;
receiving a current motor torque drive signal;
determining a compensation action the current motor torque drive signal;
determining a compensation value based on the compensation action and the table; and
generating a motor torque drive signal based on the compensation value.

2. The control method of claim 1, wherein the compensation action comprises modification of a control function.

3. The control method of claim 1, wherein the compensation action comprises cessation of a control action.

4. The control method of claim 1, wherein the cessation is momentarily.

5. The control method of claim 1, wherein the cessation is sustained.

6. The control method of claim 1, further comprising determining a change in system dynamics based on the motor torque drive signal, and wherein the determining the compensation action is based on the change in system dynamics.

7. The control method of claim 1, further comprises determining a compensation value of the compensation values based on an estimation method comprising:
monitoring a torque drive signal to the electric power steering system;
monitoring a torque sensor signal from a torque sensor of the electric power steering system; and
estimating, by a processor, a compensation value based on a transfer function associated with the torque drive signal and the torque sensor signal.

8. The control method of claim 7, wherein the estimation method further comprises generating a modified torque drive signal to the electric power steering system, and wherein the monitoring the torque drive signal and the monitoring the torque sensor signal occurs during the generating the modified torque drive signal.

9. The control method of claim 8, wherein the generating the modified torque drive signal comprises generating a dithered control signal.

10. The control method of claim 9, wherein the generating the modified torque signal comprises generating the dithered control signal at various frequencies.

11. The control method of claim 7, wherein the estimation method further comprises determining a transfer functions for each of a plurality of levels of torque drive signal, and wherein the estimating comprises estimating a compensation value based on the transfer functions for the plurality of levels.

12. The control method of claim 11, wherein the estimation method further comprises segmenting data of the transfer functions based on a frequency range.

13. The control method of claim 12, wherein the estimation method further comprises evaluating the segmented data at the frequency range to determine a relationship between torque drive and frequency, and wherein the estimating the compensation value is based on the relationship.

14. The control method of claim 7, wherein the compensation value is at least one of a phase value and a gain value.

15. The control method of claim 7, wherein the estimation method further comprises populating the compensation table based on the compensation value.

16. The control method of claim 7, wherein the estimation method further comprises performing a steering maneuver while driving the vehicle a speed X for a period of time Y, and wherein the monitoring the torque drive signal and the monitoring the torque sensor signal occurs during the performing the steering maneuver.

17. The control method of claim 16, wherein the steering maneuver produces data that represents continuous transient steering events that demand various amounts of motor torque.

18. The control method of claim 16, wherein the steering maneuver includes steering from left to right and right to left as the vehicle is being driven at the speed X over the period of time Y.

19. A system, comprising:
an electric power steering system;
a torque sensor associated with the electric power steering system; and
a first module that stores a compensation table having compensation values that are associated with motor torque drive values, that receives a current motor torque drive signal, that determines a compensation action the current motor torque drive signal, that determines a compensation value based on the compensation action and the table, and that generates a motor torque drive signal based on the compensation value.

20. The system of claim 19, further comprising:
a second module that monitors a torque drive signal to the electric power steering system, that monitors a torque sensor signal from the torque sensor, that determines a compensation value based on a transfer function associated with the torque drive signal and the torque sensor signal, and that provides the compensation value to the first module.
